(19) United States
(12) Patent Application Publication
(10) Pub. No.: US 2019/0363395 A1
(43) Pub. Date: Nov. 28, 2019

(54) THIN FILM SOLID-STATE SECONDARY BATTERY

(71) Applicant: Li Xiang Chen, Taipei (TW)

(72) Inventor: Li Xiang Chen, Taipei (TW)

(21) Appl. No.: 15/985,719

(22) Filed: May 22, 2018

(51) Int. Cl. H01M 10/0525; H01M 10/04

(52) U.S. Cl. CPC H01M 10/0525; H01M 10/045

(57) ABSTRACT

Constituents of the thin film solid-state secondary battery comprises a solid electrolyte charged-ion permeable layer, a negative electrode layer and a positive electrode layer; the negative electrode layer is disposed on one surface of the solid electrolyte charged-ion permeable layer, and sequentially includes a negative electrode charged-ion layer, a graphene layer, and a complex ionic oxide layer, and a negative electrode current collector layer; the positive electrode layer is disposed on the other surface of the solid electrolyte charged-ion permeable layer, and sequentially includes a positive electrode ion layer, a graphene layer, a complex ionic oxide layer, and a positive electrode current collector layer. Each of the above layer structures can be coated to form a coating layer or plated to form a plating layer. By this construction, a safe, lightweight, high energy density and high-cycle innovative battery can be constructed.

### BACKGROUND OF INVENTION

### 1. Field of the Invention

The present invention relates generally to a secondary battery, and more particularly to a thin film solid-state secondary battery.

### 2. Description of Related Art

Lithium-ion secondary batteries or lithium-ion batteries have attracted much attention, and have been widely used in various electronic products such as notebook computers and mobile phones. In secondary batteries, the reactions to generate electrons and consume electrons are mostly reversible reactions. Therefore, these batteries can be electrochemically cycled between the charged state and the discharged state.

Portable electronic devices have been developed toward miniaturization and light weight, and their performance has also been greatly improved. Therefore, there is a need to develop rechargeable lithium batteries or secondary lithium batteries that are cost-effective and have high energy density and high output. In addition, especially in a high-temperature environment, after a certain number of storage and cycles, some lithium batteries may generate gas, which will reduce the life of the lithium battery. Therefore, it is necessary to provide a robust battery cell that can prolong its service life for application in the field of thin film lithium batteries.

The main difference between all-solid-state thin film lithium batteries and traditional lithium-ion batteries is that traditional lithium-ion batteries use liquid electrolytes, while all-solid-state thin film lithium batteries use solid/colloidal electrolytes. Use of solid/colloidal electrolytes can improve many disadvantages of liquid electrolytes. The main advantages of all-solid-state thin film lithium batteries are thinness, high safety, high-temperature charge and discharge, long life, high charge and discharge current tolerance, and flexibility, etc. Therefore, all-solid-state thin film lithium batteries can be fabricated on various substrates with simple and good circuit designs.

However, the volumetric energy density of all-solid-state thin film lithium batteries cannot be effectively increased due to limitations in process technology. Therefore, how to overcome the bottleneck in the process technology of all-solid-state thin film lithium batteries has become an important issue. At present, the industry has conducted related technology research on all-solid-state thin film lithium batteries, but it is still unable to solve the bottleneck in the process technology of all-solid-state thin film lithium batteries to effectively increase the volumetric energy density. Therefore, how to propose an all-solid-state thin-film lithium battery and its manufacturing method to effectively improve the situation where the volumetric energy density of the solid-state thin-film lithium batteries of the prior art is unable to be effectively increased has become an urgent issue.

### SUMMARY OF THE INVENTION

In view of the above problems of the prior art, the objective of the present invention is to provide a thin film solid-state secondary battery to solve the problems that the volumetric energy density of conventional solid-state thin film lithium battery cannot be effectively improved.

Another objective of the present invention is to provide a thin film solid-state secondary battery with improved electric capacity, service life, safety performance and high temperature resistance.

Another objective of the present invention is to provide a thin film solid-state secondary battery with excellent mobility of charged ions, large overall electrical conductivity, and improved electricity storage property.

According to the above objectives, the present invention provides a thin film solid-state secondary battery, comprising a positive electrode current collector layer; a complex ionic oxide layer laminated on the surface of the positive electrode current collector layer; a graphene layer laminated on the surface of the complex ionic oxide layer; a positive electrode ion layer laminated on the surface of the graphene layer; a solid electrolyte charged-ion permeable layer laminated on the surface of the positive electrode ion layer; a negative electrode charged-ion layer laminated on the surface of the solid electrolyte charged-ion permeable layer; a graphene layer laminated on the surface of the negative electrode charged-ion layer; a complex ionic oxide layer laminated on the surface of graphene layer; a negative electrode current collector layer laminated on the surface of the complex ionic oxide layer.

The thickness of the complex ionic oxide layer on the surface of the positive electrode current collector layer and the complex ionic oxide layer on the surface of the graphene layer is 0.5˜3 nm.

The above positive electrode current collector layer is mainly made of aluminum foil conductor and has a thickness of 15˜300 nm.

The above graphene layer is made of a very thin network structure of carbon atoms with a very good mobility, so that the overall conductivity and power storage capacity are significantly increased, and its thickness is 0.5˜3 nm.

The positive electrode ion layer and the complex ionic oxide layer on the surface of the positive electrode current collector layer are positive electrode composite materials having charge and discharge properties, and may be selected from any of lithium cobaltate, lithium manganate, and lithium nickelate. By its long cycle life, excellent safety performance, better high temperature performance and relatively low price, the overall performance of lithium battery is improved or increased.

The above solid electrolyte charged-ion permeable layer is a polymer which has channels for rapid migration of charged ions, and has a high conductivity. Further, because of the solid-state type there are restrictions on the shape and thickness of ceramic polymer. Its thickness is 50˜300 nm.

The thickness of the negative electrode charged-ion layer and the positive electrode ion layer is 10˜30 nm.

The negative electrode charged-ion layer and the complex ionic oxide layer on the surface of graphene layer are negative electrode composite materials having charge and discharge properties, and may be selected from any of carbon, silicon or titanium to improve the electric capacity and service life, and enhance the overall performance of lithium batteries.

The above negative electrode current collector layer is mainly made of copper foil conductor and has a thickness of 8˜300 nm.

In the preparation of thin film solid-state secondary battery of the present invention, coating or plating such as Chemical Vapor Deposition (CVD) technique, Physical Vapor Deposition (PVD) technique may be used, or even a Plasma Enhanced Chemical Vapor Deposition (PECVD) may be used. All structural layers are in the form of coating or plating.

Every layer of thin film solid-state secondary battery is sequentially implemented by stacking a predetermined thickness, so as to constitute a safe, lightweight, high energy density and high-cycle innovative secondary battery. Through the aforementioned stacking regulation, a positive electrode current collector layer may be selected as a base layer, or a negative electrode current collector layer may be selected as a base layer, in order to complete the stacking process by coating or plating layer-by-layer to form a complete thin film solid-state secondary battery.

### BRIEF DESCRIPTION OF THE DRAWINGS

FIG. 1 is a structural schematic diagram of a better embodiment of the present invention.

FIG. 2 is a structural schematic diagram of another better embodiment of the present invention.

### DETAILED DESCRIPTION OF THE INVENTION

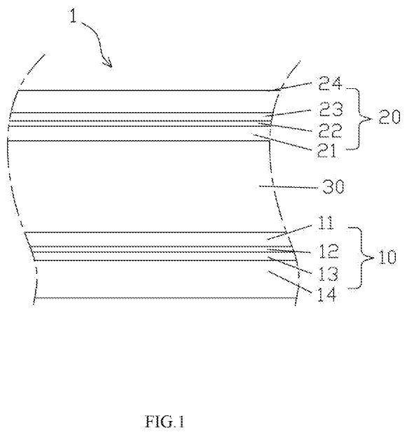

Referring to FIG. 1, which is a schematic diagram of an embodiment of a thin film solid-state secondary battery. As shown in the figure, the constituents of the thin film solid-state secondary battery 1 comprises a positive electrode layer 10, a negative electrode layer 20, and a solid electrolyte charged-ion permeable layer 30; the positive electrode layer 10 is disposed on one surface of the solid electrolyte charged-ion permeable layer 30, and sequentially stacked with a positive electrode ion layer 11, a graphene layer 12, a complex ionic oxide layer 13, and a positive electrode current collector layer 14; the negative electrode layer 20 is disposed on the other surface of the solid electrolyte charged-ion permeable layer 30, and sequentially stacked with a negative electrode charged-ion layer 21, a graphene layer 22, and a complex ionic oxide layer 23, and a negative electrode current collector layer 24.

The action of the positive electrode collector layer 14 and the negative electrode collector layer 24 themselves is to provide electrons as the conductors during charge and discharge of the battery. In choosing the material, the positive electrode current collector layer 14 is mainly aluminum foil, and the negative electrode current collector layer 24 is mainly copper foil.

The positive electrode ion layer 11 and the complex ionic oxide layer 13 in the positive electrode layer 10 are positive electrode composite materials having charge and discharge performance, and may be selected from any of lithium cobaltate, lithium manganate, and lithium nickelate in the implementation of lithium battery. By its long cycle life, excellent safety performance, better high temperature performance and relatively low price, the overall performance of lithium battery is improved or increased.

The graphene layers 12 and 22 are made of an ultra-thin network structure of carbon atoms, so the migration of charged ions is little limited. Therefore, they have very good mobility to allow the charged ions in the graphene layers 12, 22 to approach light speed motion, making the overall electrical conductivity and power storage property greatly improved.

The solid electrolyte charged-ion permeable layer 30 is a polymer. In this embodiment, a ceramic solid electrolyte is used to replace the electrolyte as an intermediate isolation layer between the positive electrode layer 10 and the negative electrode layer 20; the solid electrolyte charged-ion permeable layer 30 has channels for rapid migration of charged ions with a higher conductivity, and because of the solid-state type there are restrictions on the shape and thickness.

The negative electrode charged-ion material layer 21 and the complex ionic oxide layer 23 in the negative electrode layer 20 are negative electrode composite materials having charge and discharge performance, and may be selected from any of carbon, silicon or titanium in the implementation of lithium battery to improve electric capacity and service life, and enhance the overall performance of lithium batteries.

In the preparation of thin film solid-state secondary battery of the present invention, coating or plating such as Chemical Vapor Deposition (CVD) technique, Physical Vapor Deposition (PVD) technique may be used, or even a Plasma Enhanced Chemical Vapor Deposition (PECVD) may be used.

For the thin film solid-state secondary battery 1 provided by the present invention, in a better embodiment, the range of thickness of each layer is as follows: the thickness of the solid electrolyte charged-ion permeable layer 30 is 50˜300 nm; the thickness of the complex ionic oxide layer 13, 23 in the positive electrode layer 10 and the negative electrode layer 20 is 0.5˜3 nm; the thickness of the graphene layers 12, 22 in the positive electrode layer 10 and the negative electrode layer 20 is 0.5˜3 nm; the thickness of the negative electrode charged-ion layer 21 and the positive electrode ion layer 11 is 10˜30 nm; the thickness of the positive electrode current collector layer 14 is 15˜300 nm; the thickness of the negative electrode current collector layer 24 is 8˜300 nm.

Every layer of the above thin film solid-state secondary battery 1 is sequentially implemented by stacking a predetermined thickness, so as to constitute a safe, lightweight, high energy density and high-cycle innovative secondary battery. Through the aforementioned stacking regulation, a positive electrode current collector layer 14 may be selected as a base layer, or a negative electrode current collector layer 24 may be selected as a base layer, in order layer-by-layer to complete the stacking process by coating or plating to form a whole thin film solid-state secondary battery 1. Take examples as follows:

The first embodiment uses the positive electrode current collector layer as a base layer and selects coating or plating process to implement. The sequence for laminating each layer is as follows: the positive electrode current collector layer 14 serves as a base layer; the complex ionic oxide layer 13 is laminated on the surface of the positive electrode current collector layer 14; the graphene layer 12 is laminated on the surface of the complex ionic oxide layer 13; the positive electrode ion layer 11 is laminated on the surface of the graphene layer 12; the solid electrolyte charged-ion permeable layer 30 is laminated on the surface of the positive ion layer 11; the negative electrode charged-ion material layer 21 is laminated on the surface of the solid electrolyte charged-ion permeable layer 30; the graphene layer 22 is laminated on the surface of the negative electrode charged-ion layer 21; the complex ionic oxide layer 23 is laminated on the surface of the graphene layer 22; the negative electrode current collector layer 24 is laminated on the surface of the complex ionic oxide layer 23.

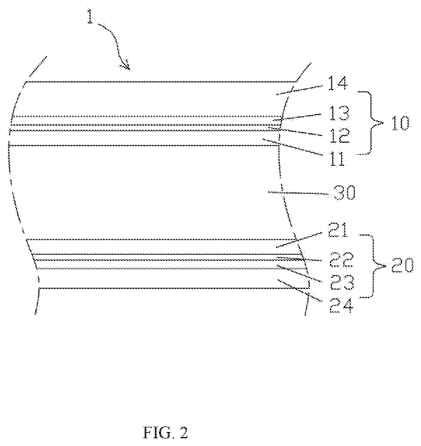

Referring to FIG. 2, the second embodiment uses the negative electrode current collector layer 24 as a base layer and likewise selects coating or plating process to implement. The sequence for laminating each layer is as follows: the negative electrode current collector layer 24 serves as a base layer; the complex ionic oxide layer 23 is laminated on the surface of the negative electrode current collector layer 24; the graphene layer 22 is laminated on the surface of the complex ionic oxide layer 23; the negative electrode charged-ion layer 21 is laminated on the surface of the graphene layer 22; the solid electrolyte charged-ion permeable layer 30 is laminated on the surface of the negative electrode charged-ion layer 21; the positive electrode ion layer 11 is laminated on the surface of the solid electrolyte charged-ion permeable layer 30; the graphene layer 12 is laminated on the surface of the positive electrode ion layer 11; the complex ionic oxide layer 13 is laminated on the surface of the graphene layer 12; the positive electrode current collector layer 14 is laminated on the surface of the complex ionic oxide layer 13.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

1. The constituents of a thin film solid-state secondary battery comprises:
a positive electrode current collector layer;
a complex ionic oxide layer laminated on the surface of the positive electrode current collector layer;
a graphene layer laminated on the surface of complex ionic oxide layer;
a positive electrode ion material layer laminated on the surface of graphene layer;
a solid electrolyte charged-ion permeable layer laminated on the surface of positive electrode ion layer;
a negative electrode charged-ion layer laminated on the surface of solid electrolyte charged-ion permeable layer;
a graphene layer laminated on the surface of negative electrode charged-ion layer;
a complex ionic oxide layer laminated on the surface of graphene layer;
a negative electrode current collector layer laminated on the surface of complex ionic oxide layer.

2. The structure defined in claim 1, wherein the thickness of the complex ionic oxide layer on the surface of the positive electrode current collector layer and the complex ionic oxide layer on the surface of graphene layer is 0.5˜3 nm.

3. The structure defined in claim 1, wherein the positive electrode current collector layer is a conductor mainly made of aluminum foil with thickness of 15˜300 nm.

4. The structure defined in claim 1, wherein the thickness of the graphene layer is 0.5˜3 nm.

5. The structure defined in claim 1, wherein the positive electrode ion layer and the complex ionic oxide layer on the surface of the positive electrode current collector layer are positive electrode composite materials having charge and discharge performance, and may be selected from any of lithium cobaltate, lithium manganate, and lithium nickelate.

6. The structure defined in claim 1, wherein solid electrolyte charged-ion permeable layer is a ceramic solid electrolyte with thickness of 50˜300 nm.

7. The structure defined in claim 1, wherein the thickness of the negative electrode charged-ion layer and the positive electrode ion layer 10˜30 nm.

8. The structure defined in claim 1, wherein the negative electrode charged-ion layer and the complex ionic oxide layer on the surface of the graphene layer are negative electrode composite materials having charge and discharge performance, and may be selected from any of carbon, silicon or titanium.

9. The structure defined in claim 1, wherein the negative electrode current collector layer is a conductor mainly made of copper foil with thickness of 8˜300 nm.
